(19) United States
(12) Patent Application Publication
(10) Pub. No.: US 2007/0271808 A9
(43) Pub. Date: Nov. 29, 2007

(54) Lewis acid organometallic desiccant

(75) Inventors: Jin-Shan Wang, Pittsford, NY (US); Amalkumar P. Ghosh, Rochester, NY (US); Kathleen M. Vaeth, Rochester, NY (US); Terrence R. O'Toole, Webster, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 10/946,543

(22) Filed: Sep. 21, 2004

(51) Int. Cl. F26B 21/06

(52) U.S. Cl. 34/72

(57) ABSTRACT

A desiccant for use in an electronic device that is moisture-sensitive comprising a Lewis acid organometallic structure that, when it reacts with water, forms a carbon-hydrogen bond but does not form an alcohol.

### CROSS REFERENCE TO RELATED APPLICATIONS

Reference is made to commonly assigned U.S. patent application Ser. No. ______ filed concurrently herewith by Jin-Shan Wang, et al., entitled “Desiccant Having a Reactive Salt”, the disclosure of which is herein incorporated by reference.

### FIELD OF THE INVENTION

The present invention relates to a desiccant for a microelectronic device.

### BACKGROUND OF THE INVENTION

Various microelectronic devices require humidity levels in a range of from about 2500 to below 5000 parts per million (ppm) to prevent premature degradation of device performance within a specified operating and/or storage life of the device. Control of the environment to this range of humidity levels within a packaged device is typically achieved by encapsulating the device or by sealing the device and a desiccant package within a cover. Desiccant packages include a container for receiving solid water absorbing particles (a desiccant) or providing such particles into a binder. Examples of solid water absorbing particles include molecular sieve materials, silica gel materials, calcium oxide, or calcium chloride, and the like.

Silica gel and molecular sieves are physical adsorption-type drying agents. Calcium oxide and calcium chloride are chemisorption-type drying agents. Since water adsorbed thereby is not driven off at high temperatures, they are more effective than silica gel and molecular sieves.

However, particles of calcium oxide and calcium chloride desiccants can be slow to absorb water. In addition, the handling of such particulate materials can be a problem in microelectronic devices that require clean room conditions. In addition, most desiccants are white and scatter light, or do so after absorption of water. Thus, they cannot be used in many applications where they might cover or obscure a necessary feature. In U.S. patent application Publication 2003/0110981 A1 certain metal complexes have been disclosed as desiccant materials, but these compounds release an alcohol upon water absorption that can still detrimentally interact with other materials in the device. Many of the same materials that react with water also react with alcohols.

Organic light emitting diode (OLED) devices are one class of moisture-sensitive electronic devices that can benefit from improved desiccants that do not have the above problems. In particular, so-called top-emitting OLED devices have a need for an effective transparent desiccant that can be applied over the light emitting layers.

### SUMMARY OF THE INVENTION

It is therefore an object of the present invention to provide a highly effective moisture absorbing desiccant and which is transparent.

This object is achieved by a desiccant for use in an electronic device that is moisture-sensitive comprising a Lewis acid organometallic structure that, when it reacts with water, forms a carbon-hydrogen bond but does not form an alcohol.

### ADVANTAGES

The invention provides a desiccant material that has rapid water absorption, does not release harmful byproducts, and that is substantially transparent to visible light. Alcohols are not formed when the desiccant material reacts with water.

### BRIEF DESCRIPTION OF THE DRAWINGS

FIG. 1 is a cross-sectional view of an OLED device;

FIG. 2 is a plan view of an OLED substrate with a first electrode and contact pads;

FIG. 3 shows the OLED of FIG. 2 after deposition of a patterned insulator layer;

FIG. 4A is a plan view of the OLED from FIG. 3 after deposition of the organic EL media and second electrode;

FIG. 4B is a cross sectional view of the OLED device of FIG. 4A taken along lines 4B;

FIG. 5A is a plan view of a protective cover with a recessed area;

FIG. 5B is a cross sectional view of the cover from FIG. 5A taken along lines 5B;

FIG. 5C is a cross sectional view of the cover after desiccant has been added to the recessed area;

FIG. 6 shows an encapsulated OLED device; and

FIG. 7 shows another encapsulated OLED device.

### DETAILED DESCRIPTION OF THE INVENTION

The moisture absorbing material of this invention includes a Lewis acid organometallic structure that, when it reacts with water, forms a carbon-hydrogen bond but does not form an alcohol. In one preferred embodiment, the Lewis acid has the structure shown in Formula I
R¹ₙ-M-R²ₘ (I)
wherein:

M is a metal;

R¹ is an organic substituent wherein at least one carbon is directly bonded to the metal;

R² is a silyl oxide substituent wherein the oxygen is directly bonded to the metal, or an amide substituent having a nitrogen directly bonded to the metal; and

n=1, 2, 3, or 4 and m=0, 1, 2, or 3 and are selected to fulfill the coordination requirements of M so that Formula I is neutral in charge.

Metals selected from Group IIB, IIIA, IIIB, or IVB, or first row transition metals are useful in present invention. Preferably, they are Al, Zn, Ti, Mg, or B.

When more than one R¹ substituent is used, the R¹ substituents can be the same or different from each other. Likewise, when more than one R² substituent is used, the R² substituents can be the same or different from each other.

Some useful examples of organic substituents that can be used as R¹ include alkyl, alkenyl, aryl, or heteroaryl compounds where a saturated or unsaturated carbon is bonded to the metal. These compounds can be further substituted with alkyl, alkenyl, aryl, heteroaryl, halogen, cyano, ether, ester, or tertiary amine groups, or combinations thereof. Some non-limiting examples of R¹ include methyl, ethyl, n-propyl, n-butyl, n-pentyl, n-hexyl, n-heptyl, n-octyl, i-propyl, t-butyl, cyclohexyl, tetradecyl, octadecyl, benzyl, phenyl, or pyridyl. In addition, R¹ can be part of an oligomeric or polymeric system. For example, R¹ can be a part of a polystyrene, polybutadiene, polymethacrylate, polysiloxane, or polyfluorene structure.

Silyl oxides with the following Formula II can be selected as R² for present invention: 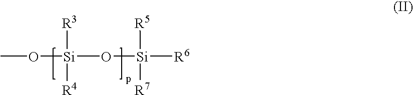
wherein R³ through R⁶ are organic substituents and p is an integer from 0 to 1000. Some organic substituents useful for R³ through R⁶ include alkyl, alkenyl, aryl, and heteroaryl compounds, which can be further substituted with alkyl, alkenyl, aryl, heteroaryl, halogen, cyano, ether, ester, or tertiary amine groups, or combinations thereof. Preferably R³ through R⁶ are alkyl or aryl groups.

Amides with the following Formula III can be selected as R² for present invention: 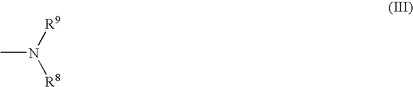
wherein R⁸ and R⁹ are organic substituents. Some organic substituents useful for R⁸ and R⁹ include alkyl, alkenyl, aryl, or heteroaryl compounds, which can be further substituted with alkyl, alkenyl, aryl, heteroaryl, halogen, cyano, ether, ester, or tertiary amine groups, or combinations thereof. R⁸ and R⁹ can be joined to form a ring system such as. R⁸ or R⁹, or both, can be part of an oligomeric or polymeric system. For example, R⁸ or R⁹ can be a part of a polystyrene, polybutadiene, polymethacrylate, polysiloxane, or polyfluorene structure.

Although not shown in Formula I, there can be additional, non charge-bearing moieties weakly or strongly coordinated to the metal center. For example, there can be solvent molecules coordinated to the metal center in addition to R¹.

Examples of useful desiccant materials of this invention include, but are not limited to, Al(C₂H₅)₃, Al(C₄H₉)₃, B(C₄H₉)₃, Zn(C₄H₉)₂, Al(t-butyl)₃, Ti(t-butyl)₄, Mg(t-butyl)₂, Al(C₄H₉)₂(N(C₆H₅)₂), Al(C₄H₉)(N(C₆H₅)₂)₂, and the structures shown below:

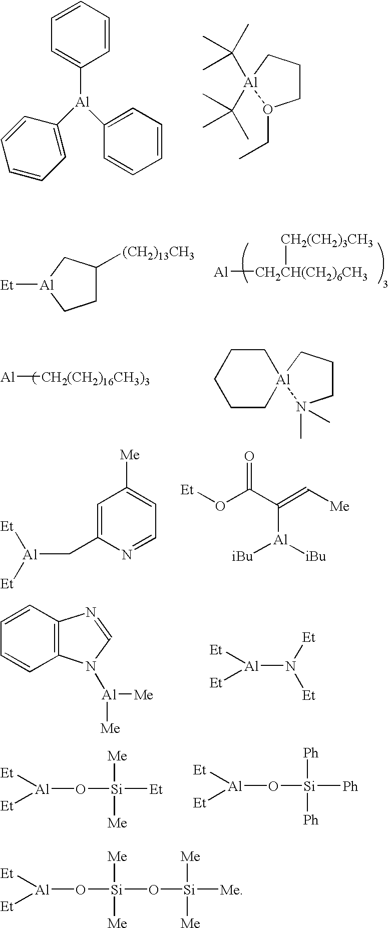

Equations 1-3 show how these moisture-absorbing materials react with water, using various examples of R¹ and R² Formula I wherein M is aluminum. For example:
Al(C₄H₉)₃+3H₂O→3C₄H₁₀+Al(OH)₃ (1)
Al(C₄H₉)((OSi(CH₃)₂)₅₀C₂H₅)₂+3H₂O→C₄H₁₀+2Si(OH)(CH₃)₂)₅₀C₂H₅+Al(OH)₃ (2)
Al(C₄H₉)₂(N(C₆H₅)₂)+3H₂O→2C₄H₁₀+2NH(C₆H₅)₂+Al(OH)₃ (3).

As can be seen, R¹ of all compounds reacts with water to form a carbon-hydrogen bond. In the case of R² the reaction with water forms a silyl oxygen-hydrogen bond or a nitrogen-hydrogen bond. None of these substituents form harmful alcohol species. The reaction products are also substantially transparent to visible light. In some instances, it can be advantageous to avoid the build up gaseous byproducts. When this is desired, R¹ and R² should be selected to have 6 or more carbon atoms so that their reaction products with water have a low vapor pressure at temperatures less than 50° C.

Methods for synthesizing the Lewis acid organometallic desiccant of this invention can be found in Applied Organometallic Chemistry (John Wiley & Sons, Ltd., 2004). The Lewis acid organometallic desiccant of this invention can be used in any moisture-sensitive electronic device. In particular, these materials are ideally suited for OLED devices.

The desiccant can be incorporated into a moisture-sensitive electronic device in numerous ways. Because of the water sensitivity of these materials, and in some instances, the oxygen sensitivity, the Lewis acid organometallic desiccant of this invention should be handled under inert atmosphere conditions. It can be vapor deposited from a thermal vapor deposition source to form a film of the desiccant. The film thickness is not limited, but it is believed that a thickness range of from 0.05 microns to 500 microns is suitable, depending on the application and the required of water absorption capacity. Such a desiccant can also be codeposited with a secondary material, for example an organic material, which can help increase the permeation of water vapor throughout the film and prevent aggregation of metal oxide.

The desiccant can be dissolved in an organic solvent such as acetates, ketones, cyclohexanes and provided on the appropriate substrate, for example by spin coating, dip coating, ink jet deposition, and the like. More preferably, the desiccant can be provided in an inert polymeric matrix, for example poly(butyl methacrylate), which can be cast from an organic solvent such acetates, ketones, or cyclohexanes or mixtures thereof. A typical loading of desiccant relative to the polymer is 0.05 to 50% by weight. Other polymers that can be used include polymethacrylates, polysiloxanes, poly vinylacetate, polystyrenes, polyacrylates, polybutadiene, or cycoloefine polymers. Such layers can also be used as insulating layers in electronic devices, such as planarization layers in OLEDs.

The desiccant with or without a secondary material can be deposited by supercritical fluid deposition, for example, as described in U.S. Pat. No. 6,692,094 and U.S. patent application Publication 2004/0109951 A1.

The desiccant can also be provided into a polymer binder without the presence of solvent by heating the polymer to reduce its viscosity, and mixing in the desiccant. Upon cooling, a desiccant film is formed that can be cut to size and used in the device. Additional materials such as silica gel can be added to increase the porosity of the desiccant film, as described in WO 03/080235.

As described in EP 1 383 182, the desiccant can be provided on a first side of a support, said support having an adhesive on its second side. Thus, a sheet containing the desiccant can be applied to a portion of the device. One or more protection layers can be provided over the desiccant and removed when the desiccant sheet is applied. Such desiccant sheets can be pre-cut to simplify OLED device manufacturing.

General OLED Device Architecture

The present invention can be employed in most OLED device configurations. These include very simple structures comprising a single anode and cathode to more complex devices, such as passive matrix displays comprised of orthogonal arrays of anodes and cathodes to form pixels, and active-matrix displays where each pixel is controlled independently, for example, with thin film transistors (TFTs).

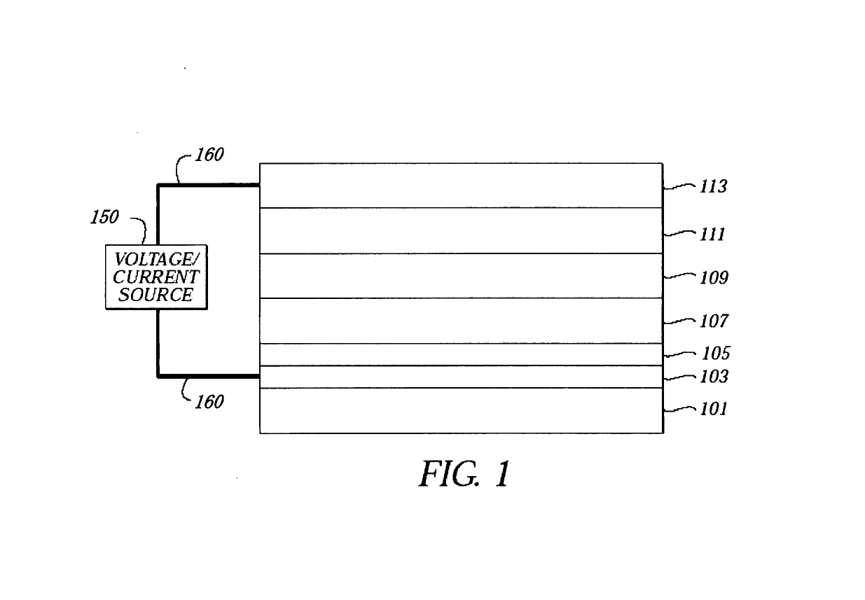

There are numerous configurations of the organic layers wherein the present invention can be successfully practiced. A schematic of a pixel area of an OLED device, not to scale, is shown in FIG. 1. It includes a substrate 101, an anode 103, a hole-injecting layer 105, a hole-transporting layer 107, a light-emitting layer 109, an electron-transporting layer 111, and a cathode 113. These layers are described in more detail below. Note that the substrate can alternatively be located adjacent to the cathode, or the substrate can actually constitute the anode or cathode. The organic layers between the anode and cathode are conveniently referred to as the organic EL element or organic EL media. The total combined thickness of the organic layers is preferably less than 500 nm.

The anode and cathode of the OLED are connected to a voltage/current source 150 through electrical conductors 160. The OLED is operated by applying a potential between the anode and cathode such that the anode is at a more positive potential than the cathode. Holes are injected into the organic EL element from the anode and electrons are injected into the organic EL element at the anode. Enhanced device stability can sometimes be achieved when the OLED is operated in an alternating current (AC) mode where, for some time period in the cycle, the potential bias is reversed and no current flows. An example of an AC driven OLED is described in U.S. Pat. No. 5,552,678.

Substrate

The OLED device of this invention is typically provided over a supporting substrate where either the cathode or anode can be in contact with the substrate. The substrate can have a simple or a complex structure with numerous layers, for example, a glass support with electronic elements such as TFT elements, planarizing layers, and wiring layers. The electrode in contact with the substrate is conveniently referred to as the bottom electrode. Conventionally, the bottom electrode is the anode, but this invention is not limited to that configuration. The substrate can either be light transmissive or opaque, depending on the intended direction of light emission. The light transmissive property is desirable for viewing the EL emission through the substrate. Transparent glass or plastic is commonly employed in such cases. For applications where the EL emission is viewed through the top electrode, the transmissive characteristic of the bottom support is immaterial, and therefore can be light transmissive, light absorbing, or light reflective. Substrates for use in this case include, but are not limited to, glass, plastic, semiconductor materials, silicon, ceramics, and circuit board materials. Of course, it is necessary to provide in these device configurations a light-transparent top electrode.

Anode

When EL emission is viewed through anode 103, the anode should be transparent or substantially transparent to the emission of interest. Common transparent anode materials used in this invention are indium-tin oxide (ITO), indium-zinc oxide (IZO) and tin oxide, but other metal oxides can work including, but not limited to, aluminum- or indium-doped zinc oxide, magnesium-indium oxide, and nickel-tungsten oxide. In addition to these oxides, metal nitrides, such as gallium nitride, and metal selenides, such as zinc selenide, and metal sulfides, such as zinc sulfide, can be used as the anode. For applications where EL emission is viewed only through the cathode electrode, the transmissive characteristics of anode are immaterial and any conductive material can be used, transparent, opaque, or reflective. Example conductors for this application include, but are not limited to, gold, iridium, molybdenum, palladium, and platinum. Typical anode materials, transmissive or otherwise, have a work function of 4.1 eV or greater. Desired anode materials are commonly deposited by any suitable way such as evaporation, sputtering, chemical vapor deposition, or electrochemical means. Anodes can be patterned using well known photolithographic processes. Optionally, anodes can be polished prior to application of other layers to reduce surface roughness so as to reduce shorts or enhance reflectivity.

Hole-Infecting Layer (HIL)

While not always necessary, it is often useful to provide a hole-injecting layer 105 between anode 103 and hole-transporting layer 107. The hole-injecting material can serve to improve the film formation property of subsequent organic layers and to facilitate injection of holes into the hole-transporting layer. Suitable materials for use in the hole-injecting layer include, but are not limited to, porphyrinic compounds as described in U.S. Pat. No. 4,720,432, plasma-deposited fluorocarbon polymers as described in U.S. Pat. Nos. 6,127,004, 6,208,075, and 6,208,077, some aromatic amines, for example, m-MTDATA (4,4′,4″-tris[(3-methylphenyl)phenylamino]triphenylamine), and inorganic oxides including vanadium oxide (VOx), molybdenum oxide (MoOx), and nickel oxide (NiOx). Alternative hole-injecting materials reportedly useful in organic EL devices are described in EP 0 891 121 A1 and EP 1 029 909 A1.

Hole-Transporting Layer (HTL)

The hole-transporting layer 107 contains at least one hole-transporting compound such as an aromatic tertiary amine, where the latter is understood to be a compound containing at least one trivalent nitrogen atom that is bonded only to carbon atoms, at least one of which is a member of an aromatic ring. In one form the aromatic tertiary amine can be an arylamine, such as a monoarylamine, diarylamine, triarylamine, or a polymeric arylamine. Exemplary monomeric triarylamines are illustrated by Klupfel et al. U.S. Pat. No. 3,180,730. Other suitable triarylamines substituted with one or more vinyl radicals and/or comprising at least one active hydrogen containing group are disclosed by Brantley et al U.S. Pat. Nos. 3,567,450 and 3,658,520.

A more preferred class of aromatic tertiary amines are those which include at least two aromatic tertiary amine moieties as described in U.S. Pat. Nos. 4,720,432 and 5,061,569. The hole-transporting layer can be formed of a single or a mixture of aromatic tertiary amine compounds. Illustrative of useful aromatic tertiary amines are the following:

1,1-Bis(4-di-p-tolylaminophenyl)cyclohexane;

1,1-Bis(4-di-p-tolylaminophenyl)-4-phenylcyclohexane;

N,N,N′,N′-tetraphenyl-4,4′″-diamino-1,1′:4′,1″:4″,1′″-quaterphenyl;

Bis(4-dimethylamino-2-methylphenyl)phenylmethane;

1,4-bis[2-[4-[N,N-di(p-toly)amino]phenyl]vinyl]benzene (BDTAPVB);

N,N,N′,N′-Tetra-p-tolyl-4,4′-diaminobiphenyl;

N,N,N′,N′-Tetraphenyl-4,4′-diaminobiphenyl;

N,N,N′,N′-tetra-1-naphthyl-4,4′-diaminobiphenyl;

N,N,N′,N′-tetra-2-naphthyl-4,4′-diaminobiphenyl;

N-Phenylcarbazole;

4,4′-Bis[N-(1-naphthyl)-N-phenylamino]biphenyl (NPB);

4,4′-Bis[N-(1-naphthyl)-N-(2-naphthyl)amino]biphenyl (TNB);

4,4′-Bis[N-(1-naphthyl)-N-phenylamino]p-terphenyl;

4,4′-Bis[N-(2-naphthyl)-N-phenylamino]biphenyl;

4,4′-Bis[N-(3-acenaphthenyl)-N-phenylamino]biphenyl;

1,5-Bis[N-(1-naphthyl)-N-phenylamino]naphthalene;

4,4′-Bis[N-(9-anthryl)-N-phenylamino]biphenyl;

4,4′-Bis[N-(1-anthryl)-N-phenylamino]-p-terphenyl;

4,4′-Bis[N-(2-phenanthryl)-N-phenylamino]biphenyl;

4,4′-Bis[N-(8-fluoranthenyl)-N-phenylamino]biphenyl;

4,4′-Bis[N-(2-pyrenyl)-N-phenylamino]biphenyl;

4,4′-Bis[N-(2-naphthacenyl)-N-phenylamino]biphenyl;

4,4′-Bis[N-(2-perylenyl)-N-phenylamino]biphenyl;

4,4′-Bis[N-(1-coronenyl)-N-phenylamino]biphenyl;

2,6-Bis(di-p-tolylamino)naphthalene;

2,6-Bis[di-(1-naphthyl)amino]naphthalene;

2,6-Bis[N-(1-naphthyl)-N-(2-naphthyl)amino]naphthalene;

N,N,N′,N′-Tetra(2-naphthyl)-4,4″-diamino-p-terphenyl;

4,4′-Bis{N-phenyl-N-[4-(1-naphthyl)-phenyl]amino}biphenyl;

2,6-Bis[N,N-di(2-naphthyl)amino]fluorene;

4,4′,4″-tris[(3-methylphenyl)phenylamino]triphenylamine (MTDATA); and

4,4′-Bis[N-(3-methylphenyl)-N-phenylamino]biphenyl (TPD).

Another class of useful hole-transporting materials includes polycyclic aromatic compounds as described in EP 1 009 041. Some hole-injecting materials described in EP 0 891 121 A1 and EP 1 029 909 A1 can also make useful hole-transporting materials. In addition, polymeric hole-transporting materials can be used including poly(N-vinylcarbazole) (PVK), polythiophenes, polypyrrole, polyaniline, and copolymers including poly(3,4-ethylenedioxy-thiophene)/poly(4-styrenesulfonate), also called PEDOT/PSS.

Light-Emitting Layer (LEL)

As more fully described in U.S. Pat. Nos. 4,769,292 and 5,935,721, each of the light-emitting layers (LEL) of the organic EL element include a luminescent fluorescent or phosphorescent material where electroluminescence is produced as a result of electron-hole pair recombination in this region. The light-emitting layer can be comprised of a single material, but more commonly contains a host material doped with a guest emitting material or materials where light emission comes primarily from the emitting materials and can be of any color. This guest emitting material is often referred to as a light emitting dopant. The host materials in the light-emitting layer can be an electron-transporting material, as defined below, a hole-transporting material, as defined above, or another material or combination of materials that support hole-electron recombination. The emitting material is typically chosen from highly fluorescent dyes and phosphorescent compounds, e.g., transition metal complexes as described in WO 98/55561, WO 00/18851, WO 00/57676, and WO 00/70655. Emitting materials are typically incorporated at 0.01 to 10% by weight of the host material.

The host and emitting materials can be small nonpolymeric molecules or polymeric materials including polyfluorenes and polyvinylarylenes, e.g., poly(p-phenylenevinylene), PPV. In the case of polymers, small molecule emitting materials can be molecularly dispersed into a polymeric host, or the emitting materials can be added by copolymerizing a minor constituent into a host polymer.

An important relationship for choosing an emitting material is a comparison of the bandgap potential which is defined as the energy difference between the highest occupied molecular orbital and the lowest unoccupied molecular orbital of the molecule. For efficient energy transfer from the host to the emitting material, a necessary condition is that the band gap of the dopant is smaller than that of the host material. For phosphorescent emitters (including materials that emit from a triplet excited state, i.e., so-called “triplet emitters”) it is also important that the host triplet energy level of the host be high enough to enable energy transfer from host to emitting material.

Host and emitting materials known to be of use include, but are not limited to, those disclosed in U.S. Pat. Nos. 4,768,292, 5,141,671, 5,150,006, 5,151,629, 5,405,709, 5,484,922, 5,593,788, 5,645,948, 5,683,823, 5,755,999, 5,928,802, 5,935,720, 5,935,721, 6,020,078, 6,475,648, 6,534,199, 6,661,023, U.S. patent application Publications 2002/0127427 A1, 2003/0198829 A1, 2003/0203234 A1, 2003/0224202 A1, and 2004/0001969 A1.

Metal complexes of 8-hydroxyquinoline (oxine) and similar derivatives constitute one class of useful host compounds capable of supporting electroluminescence. Illustrative of useful chelated oxinoid compounds are the following:

CO-1: Aluminum trisoxine [alias, tris(8-quinolinolato)aluminum(III)];

CO-2: Magnesium bisoxine [alias, bis(8-quinolinolato)magnesium(II)];

CO-3: Bis[benzo{f}-8-quinolinolato]zinc (II);

CO-4: Bis(2-methyl-8-quinolinolato)aluminum(III)-μ-oxo-bis(2-methyl-8-quinolinolato)aluminum(III);

CO-5: Indium trisoxine [alias, tris(8-quinolinolato)indium];

CO-6: Aluminum tris(5-methyloxine) [alias, tris(5-methyl-8-quinolinolato)aluminum(III)];

CO-7: Lithium oxine [alias, (8-quinolinolato)lithium(I)];

CO-8: Gallium oxine [alias, tris(8-quinolinolato)gallium(III)]; and

CO-9: Zirconium oxine [alias, tetra(8-quinolinolato)zirconium(IV)].

Another class of useful host materials includes derivatives of anthracene, such as those described in U.S. Pat. Nos. 5,935,721, 5,972,247, 6,465,115, 6,534,199, 6,713,192, U.S. patent application Publications 2002/0048687 A1, 2003/0072966 A1, and WO 2004018587. Some examples include derivatives of 9,10-dinaphthylanthracene derivatives and 9-naphthyl-10-phenylanthracene. Other useful classes of host materials include distyrylarylene derivatives as described in U.S. Pat. No. 5,121,029, and benzazole derivatives, for example, 2,2′,2″-(1,3,5-phenylene)tris[1-phenyl-1H-benzimidazole].

Desirable host materials are capable of forming a continuous film. The light-emitting layer can contain more than one host material in order to improve the device's film morphology, electrical properties, light emission efficiency, and lifetime. Mixtures of electron-transporting and hole-transporting materials are known as useful hosts. In addition, mixtures of the above listed host materials with hole-transporting or electron-transporting materials can make suitable hosts.

Useful fluorescent dopants include, but are not limited to, derivatives of anthracene, tetracene, xanthene, perylene, rubrene, coumarin, rhodamine, and quinacridone, dicyanomethylenepyran compounds, thiopyran compounds, polymethine compounds, pyrilium and thiapyrilium compounds, fluorene derivatives, periflanthene derivatives, indenoperylene derivatives, bis(azinyl)amine boron compounds, bis(azinyl)methane compounds, derivatives of distryrylbenzene and distyrylbiphenyl, and carbostyryl compounds. Among derivatives of distyrylbenzene, particularly useful are those substituted with diarylamino groups, informally known as distyrylamines.

Suitable host materials for phosphorescent emitters (including materials that emit from a triplet excited state, i.e., so-called “triplet emitters”) should be selected so that the triplet exciton can be transferred efficiently from the host material to the phosphorescent material. For this transfer to occur, it is a highly desirable condition that the excited state energy of the phosphorescent material be lower than the difference in energy between the lowest triplet state and the ground state of the host. However, the band gap of the host should not be chosen so large as to cause an unacceptable increase in the drive voltage of the OLED. Suitable host materials are described in WO 00/70655, WO 01/39234, WO 01/93642, WO 02/074015, WO 02/15645, and U.S. patent application Publication 20020117662 A1. Suitable hosts include certain aryl amines, triazoles, indoles and carbazole compounds. Examples of desirable hosts are 4,4′-N,N′-dicarbazole-biphenyl (CBP), 2,2′-dimethyl-4,4′-N,N′-dicarbazole-biphenyl, m-(N,N′-dicarbazole)benzene, and poly(N-vinylcarbazole), including their derivatives.

Examples of useful phosphorescent materials that can be used in light-emitting layers of this invention include, but are not limited to, those described in WO 00/57676, WO 00/70655, WO 01/41512, WO 02/15645, WO 01/93642, WO 01/39234, WO 02/071813, WO 02/074015, U.S. patent application Publications 2003/0017361 A1, 2002/0197511 A1, 2003/0124381 A1, 2003/0059646 A1, 2003/0054198 A1, 2003/0072964 A1, 2003/0068528 A1, 2002/0100906 A1, 2003/0068526 A1, 2003/0068535 A1, 2003/0141809 A1, 2003/0040627 A1, 2002/0121638 A1, U.S. Pat. Nos. 6,458,475, 6,573,651, 6,451,455, 6,413,656, 6,515,298, 6,451,415, 6,097,147, EP 1 239 526 A2, EP 1 238 981 A2, EP 1 244 155 A2, JP 2003-073387, JP 2003-073388, JP 2003-059667, and JP 2003-073665.

Electron-Transporting Layer (ETL)

Preferred thin film-forming materials for use in forming the electron-transporting layer 111 of the organic EL elements of this invention are metal chelated oxinoid compounds, including chelates of oxine itself (also commonly referred to as 8-quinolinol or 8-hydroxyquinoline). Such compounds help to inject and transport electrons, exhibit high levels of performance, and are readily fabricated in the form of thin films. Exemplary oxinoid compounds were listed previously.

Other electron-transporting materials include various butadiene derivatives as disclosed in U.S. Pat. No. 4,356,429 and various heterocyclic optical brighteners as described in U.S. Pat. No. 4,539,507. Benzazoles and triazines are also useful electron-transporting materials.

Cathode

When light emission is viewed solely through the anode, the cathode 113 used in this invention can be comprised of nearly any conductive material. Desirable materials have effective film-forming properties to ensure effective contact with the underlying organic layer, promote electron injection at low voltage, and have effective stability. Useful cathode materials often contain a low work function metal (<4.0 eV) or metal alloy. One preferred cathode material is comprised of a Mg:Ag alloy wherein the percentage of silver is in the range of 1 to 20%, as described in U.S. Pat. No. 4,885,221. Another suitable class of cathode materials includes bilayers comprising a thin electron-injection layer (EIL) in contact with the organic layer (e.g., ETL), which is capped with a thicker layer of a conductive metal. Here, the EIL preferably includes a low work function metal or metal salt, and if so, the thicker capping layer does not need to have a low work function. One such cathode is comprised of a thin layer of LiF followed by a thicker layer of Al as described in U.S. Pat. No. 5,677,572. Other useful cathode material sets include, but are not limited to, those disclosed in U.S. Pat. Nos. 5,059,861, 5,059,862, and 6,140,763.

A metal-doped organic layer can be used as an electron-injecting layer. Such a layer contains an organic electron-transporting material and a low work-function metal (<4.0 eV). For example, Kido et al. reported in “Bright Organic Electroluminescent Devices Having a Metal-Doped Electron-Injecting Layer”, Applied Physics Letters, 73, 2866 (1998) and disclosed in U.S. Pat. No. 6,013,384 that an OLED can be fabricated containing a low work-function metal-doped electron-injecting layer adjacent to a cathode. Suitable metals for the metal-doped organic layer include alkali metals (e.g. lithium, sodium), alkaline earth metals (e.g. barium, magnesium), or metals from the lanthanide group (e.g. lanthanum, neodymium, lutetium), or combinations thereof. The concentration of the low work-function metal in the metal-doped organic layer is in the range of from 0.1% to 30% by volume. Preferably, the concentration of the low work-function metal in the metal-doped organic layer is in the range of from 0.2% to 10% by volume. Preferably, the low work-function metal is provided in a mole ratio in a range of from 1:1 with the organic electron transporting material.

When light emission is viewed through the cathode, the cathode should be transparent or nearly transparent. For such applications, metals should be thin or one should use transparent conductive oxides, or includes these materials. Optically transparent cathodes have been described in more detail in U.S. Pat. Nos. 4,885,211, 5,247,190, 5,703,436, 5,608,287, 5,837,391, 5,677,572, 5,776,622, 5,776,623, 5,714,838, 5,969,474, 5,739,545, 5,981,306, 6,137,223, 6,140,763, 6,172,459, 6,278,236, 6,284,393, EP 1 076 368, and JP 3,234,963. Cathode materials are typically deposited by evaporation, sputtering, or chemical vapor deposition. When needed, patterning can be achieved through many well known methods including, but not limited to, through-mask deposition, integral shadow masking, for example, as described in U.S. Pat. No. 5,276,380 and EP 0 732 868, laser ablation, and selective chemical vapor deposition.

Other Common Organic Layers and Device Architecture

In some instances, layers 109 and 111 can optionally be collapsed into a single layer that serves the function of supporting both light emission and electron transportation. It also known in the art that emitting dopants can be added to the hole-transporting layer, which can serve as a host. Multiple dopants can be added to one or more layers in order to produce a white-emitting OLED, for example, by combining blue- and yellow-emitting materials, cyan- and red-emitting materials, or red-, green-, and blue-emitting materials. White-emitting devices are described, for example, in EP 1 187 235, EP 1 182 244, U.S. Pat. Nos. 5,683,823, 5,503,910, 5,405,709, 5,283,182, 6,627,333, U.S. patent application Publications 2002/0186214 A1, 2002/0025419 A1, and 2004/0009367 A1.

Additional layers such as exciton, electron and hole-blocking layers as taught in the art can be employed in devices of this invention. Hole-blocking layers are commonly used to improve efficiency of phosphorescent emitter devices, for example, as in U.S. patent application Publications 2002/0015859 A1, 2003/0068528 A1, 2003/0175553 A1, WO 00/70655, and WO 01/93642.

This invention can be used in so-called stacked device architecture, for example, as taught in U.S. Pat. Nos. 5,703,436, 6,337,492, and U.S. patent application Publication 2003/0170491 A1.

Deposition of Organic Layers

The organic materials mentioned above are suitably deposited through a vapor-phase method such as sublimation, but can be deposited from a fluid, for example, from a solvent with an optional binder to improve film formation. If the material is a polymer, solvent deposition is useful but other methods can be used, such as sputtering or thermal transfer from a donor sheet. The material to be deposited by sublimation can be vaporized from a sublimation “boat” often comprised of a tantalum material, e.g., as described in U.S. Pat. No. 6,237,529, or can be first coated onto a donor sheet and then sublimed in closer proximity to the substrate. Layers with a mixture of materials can use separate sublimation boats or the materials can be pre-mixed and coated from a single boat or donor sheet. Patterned deposition can be achieved using shadow masks, integral shadow masks (U.S. Pat. No. 5,294,870), spatially-defined thermal dye transfer from a donor sheet (U.S. Pat. Nos. 5,688,551, 5,851,709, and 6,066,357) and inkjet method (U.S. Pat. No. 6,066,357).

Optical Optimization

OLED devices of this invention can employ various well known optical effects in order to enhance its properties if desired. This includes optimizing layer thicknesses to yield maximum light transmission, providing dielectric mirror structures, replacing reflective electrodes with light-absorbing electrodes, providing anti glare or anti-reflection coatings over the display, providing a polarizing medium over the display, or providing colored, neutral density, or color conversion filters in functional relationship with the light emitting areas of the display. Filters, polarizers, and anti-glare or anti-reflection coatings can also be provided over a cover or as part of a cover.

The OLED device can have a microcavity structure. In one useful example, one of the metallic electrodes is essentially opaque and reflective; the other one is reflective and semitransparent. The reflective electrode is preferably selected from Au, Ag, Mg, Ca, or alloys thereof. Because of the presence of the two reflecting metal electrodes, the device has a microcavity structure. The strong optical interference in this structure results in a resonance condition. Emission near the resonance wavelength is enhanced and emission away from the resonance wavelength is depressed. The optical path length can be tuned by selecting the thickness of the organic layers or by placing a transparent optical spacer between the electrodes. For example, an OLED device of this invention can have ITO spacer layer placed between a reflective anode and the organic EL media, with a semitransparent cathode over the organic EL media.

Encapsulation

As stated, OLED devices are sensitive to moisture or oxygen, or both, so they are commonly sealed in an inert atmosphere such as nitrogen or argon. In sealing an OLED device in an inert environment, a protective cover can be attached using an organic adhesive, a metal solder, or a low melting temperature glass. The desiccant is also provided within the sealed space. The Lewis acid organometallic desiccant of this invention can be used in combination with other getters and desiccants including, for example, alkali and alkaline metals, alumina, bauxite, calcium sulfate, clays, silica gel, zeolites, alkaline metal oxides, alkaline earth metal oxides, sulfates, or metal halides and perchlorates. In addition, the desiccant can be used in combination with barrier layers such as SiOx, Teflon, and alternating inorganic/polymeric layers as known in the art. Barrier layers can be provided over the OLED, between the OLED and a flexible substrate, or both.

Some non-limiting examples of inorganic barrier layer materials include metal oxides such as silicon oxides and aluminum oxides, and metal nitrides such as silicon nitride. Suitable examples of inorganic barrier layer materials include aluminum oxide, silicon dioxide, silicon nitride, silicon oxynitride, and diamond-like carbon. In some circumstances it is useful if the inorganic barrier layer material can be electronically conductive, such as a conductive metal oxide, a metal or metal alloy. In this case, the conductive inorganic barrier layer can carry current to one or more device electrodes, serve as the electrode, or provide a way for discharging static electricity. Metals such as Al, Ag, Au, Mo, Cr, Pd, or Cu, or alloys containing these metals can be useful inorganic barrier layers. Multiple layers of metal can be used to fabricate a conductive inorganic barrier layer. Where unwanted shorting can occur, conductive barrier layers should not be used, or they should be patterned, e.g., with a shadow mask, such that they do not cause shorting. The inorganic barrier layer is typically provided in a thickness of 10 to several hundreds of nanometers.

Useful techniques of forming layers of inorganic barrier layer material from a vapor phase include, but are not limited to, thermal physical vapor deposition, sputter deposition, electron beam deposition, chemical vapor deposition (CVD), plasma-enhanced chemical vapor deposition, laser-induced chemical vapor deposition, and atomic layer deposition (ALD). CVD and ALD are particularly useful. In some instances, said materials can be deposited from a solution or another fluidized matrix, e.g., from a super critical solution of CO₂. Care should be taken to choose a solvent or fluid matrix does not negatively affect the performance of the device. Patterning of said materials can be achieved through many way including, but not limited to, photolithography, lift-off techniques, laser ablation, and more preferably, through shadow mask technology.

The organic barrier layer material can be monomeric or polymeric, and can be deposited using vapor deposition or from solution. If cast from solution, it is important that the deposition solution does not negatively affect the OLED device.

Conveniently, the organic barrier layer is made of a polymeric materials such as parylene materials, which can be deposited from a vapor phase to provide a polymer layer having excellent adhesion to, and step coverage over, topological features of the OLED devices, including defects such as particulate defects. The organic barrier layer is typically formed in a thickness range of from 0.01 to 5 micrometer. However, by their very nature, the organic materials in the organic barrier layer exhibit more moisture permeability than a layer formed of an inorganic dielectric material or a layer formed of a metal. Thus, it is often desirable to encase the organic barrier layer with an inorganic material.

### Embodiments

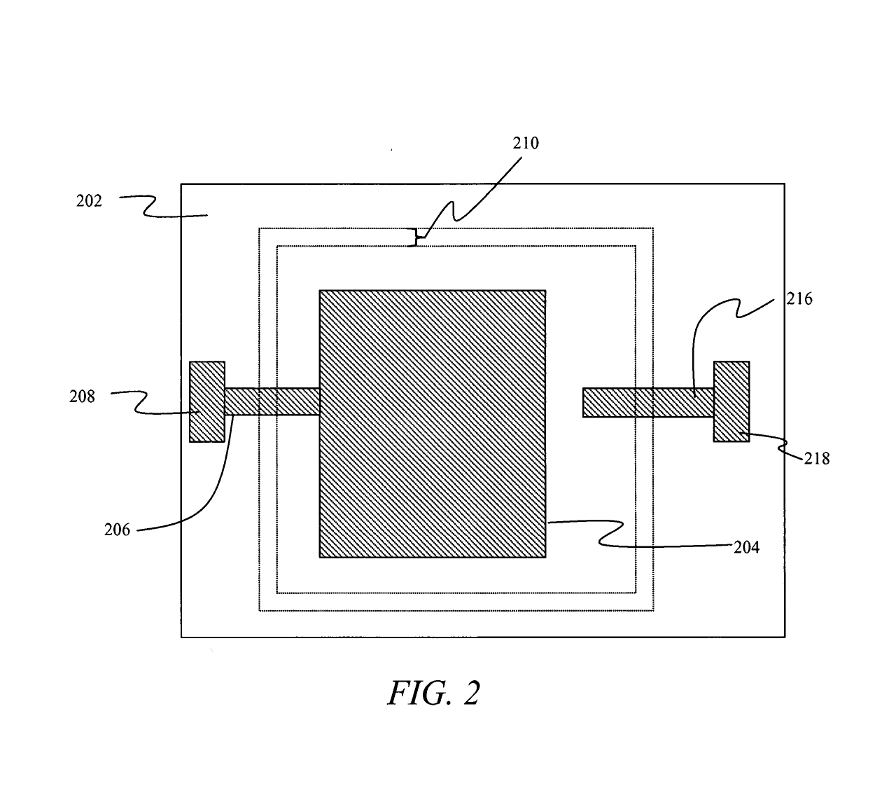

As a first embodiment, FIGS. 2-6 illustrate various stages of the fabrication of an encapsulated OLED device 200. Turning first to FIG. 2, a top view of an OLED substrate 202 is shown. A predetermined seal area 210 is represented by the space between the dotted lines in FIG. 2. The inner dotted line further represents the sealed region of the OLED device. Over OLED substrate 202 are provided a first electrode 204, a first electrical contact pad 208, and a first electrical interconnect line 206 that provides an electrical connection between the first electrode 204 and the first electrical contact pad 208. The first electrical interconnect line 206 extends through the seal area. As discussed later, the first electrode 204 can be the anode or cathode, and can be any number of well known conductive materials, as discussed above. The conductive material used for each of the first electrode 204, the first electrical interconnect line 206, and the first electrical contact pad 208 can be the same or different. In addition, each of the first electrode 204, the first electrical interconnect line 206, and the first electrical contact pad 208 can contain two or more layers of different conductive materials.

A second interconnect 216 and a second contact pad 218 are provided over the OLED substrate 202 to provide a way for making electrical contact to a second electrode that is formed in a later step. The conductive material used for the second contact pad 218 and second interconnect line 216 can be the same or different, and can also be the same or different from the material(s) used as the first electrical contact pad 208 and first electrical interconnect line 206.

The conductive materials for forming the first electrode 204, the first and second interconnect lines, and the first and second contact pads can be deposited by vacuum methods such as thermal physical vapor deposition, sputter deposition, plasma-enhanced chemical vapor deposition, electron-beam assisted vapor deposition, and other methods known in the art. In addition, so-called “wet” chemical processes can be used such as electroless and electrolytic plating. The first electrode 204, the first electrical interconnect line 206, the first electrical contact pad 208, the second interconnect line 216 and the second contact pad 218 can be provided in the same patterning step or different patterning steps. Patterning can be achieved by deposition through a shadow mask, photolithographic methods, laser ablation, selective electroless plating, electrochemical etching, and other well known patterning techniques.

The first electrode 204, interconnect lines 206 and 216, and contact pads 208 and 218 are made from aluminum. The first electrode functions as the anode, it is reflective and opaque. In order to provide a high work function surface for effective hole injection, a layer of indium-doped tin oxide (ITO) is provided over the anode (not shown). The second contact pad 218 and second interconnect line 216 are made from aluminum in this arrangement.

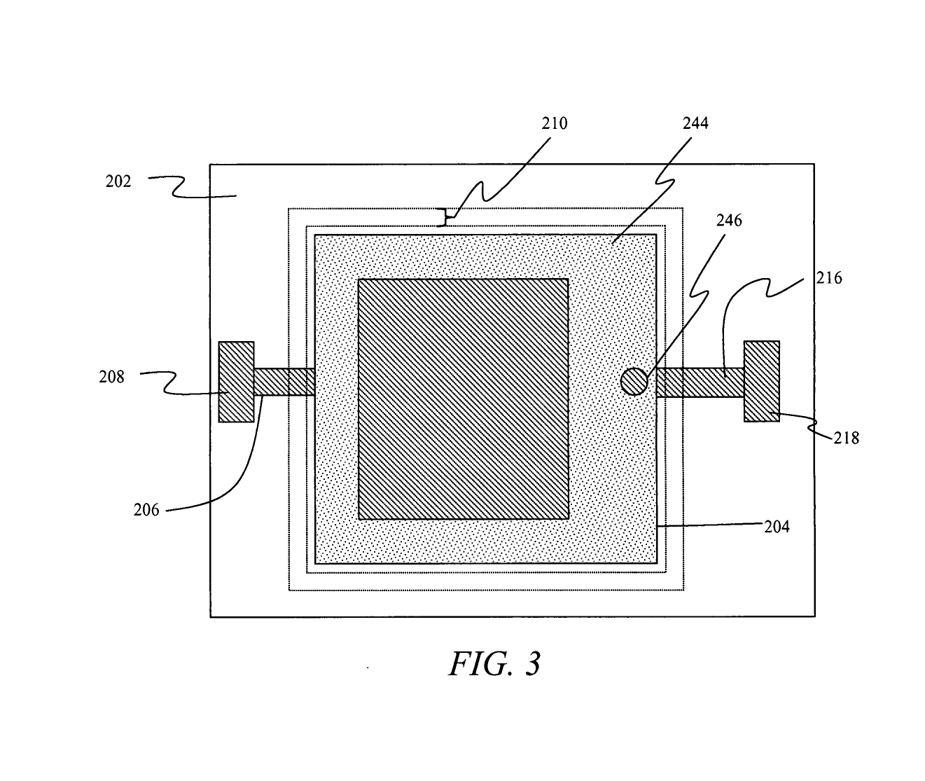

Turning now to FIG. 3, an insulation layer 244 is provided in a pattern over the OLED substrate 202. The insulation layer 244 extends over a portion of the first electrode 204 and over at least a portion of the first and second interconnects, 206 and 216. A via 246 is provided over the second interconnect line 216 that is located inside the sealed region. The insulation layer 244 does not extend through the predetermined seal area 210 in this arrangement.

The insulation layer 244 can be any number of organic or inorganic materials provided that the material has low electrical conductivity and provides effective adhesion with the surfaces over which it is applied. The insulation layer 244 acts to reduce shorting that can occur between first and second electrodes, and can provide planarization. Insulation layer 244 is typically provided in a thickness of from a few nanometers to a few microns. Many of the same materials and deposition methods can be used to form the insulation layer 244 as described above for barrier layer materials.

Some examples of organic materials that are useful for the insulation layer 244 include polyimides, parylene, and acrylate-based photoresist materials. Some examples of inorganic materials that are useful for the insulation layer 244 include metal oxides such as silicon oxides and aluminum oxides, and metal nitrides such as silicon nitride and ceramic composites. In addition, the materials can be provided from a solution, such as a sol-gel. For the purposes of discussion, a sol-gel material that has high planarizing ability is used as the insulation layer 244 in this arrangement.

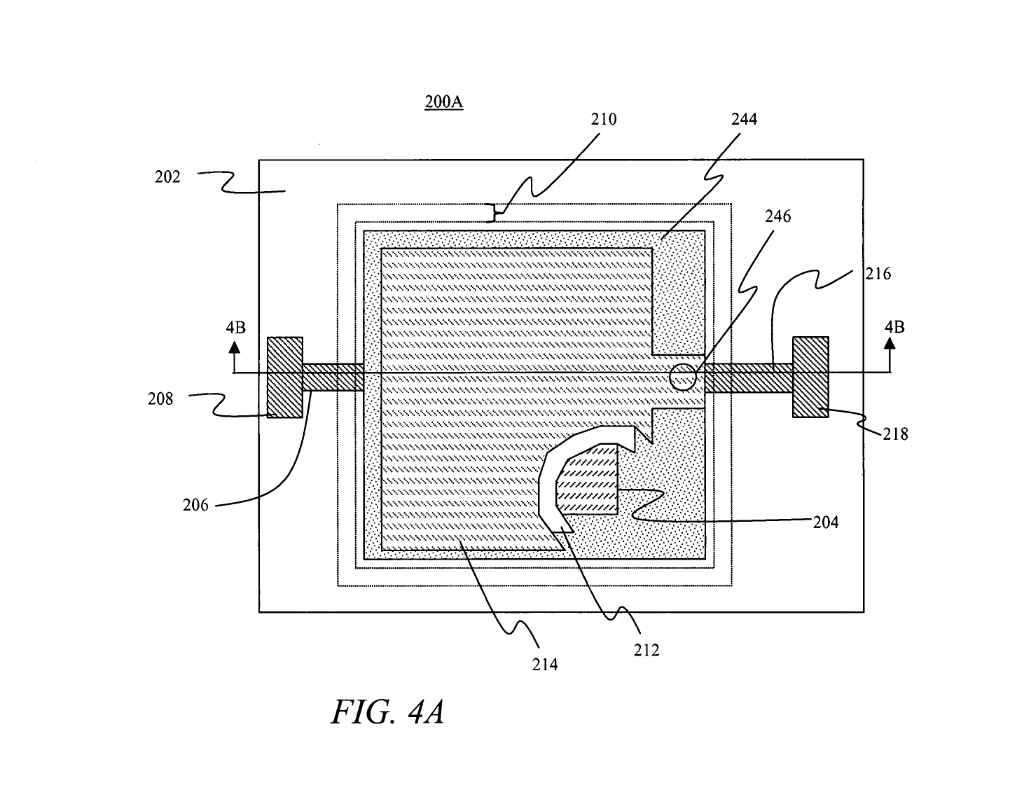

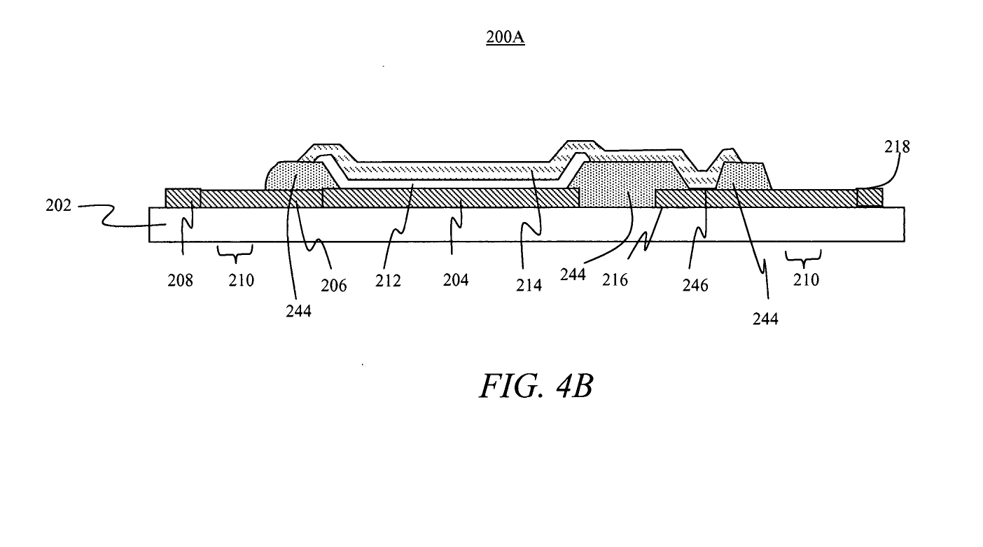

As shown in FIG. 4A, the organic EL media layer 212 and second electrode 214 are then deposited to make OLED device 200A. To illustrate the layer order, the lower right corner of first electrode area is pictorially cut away to show the first electrode 104. A cross-sectional view taken along lines 4B is shown in FIG. 4B. The second electrode is the cathode and is semitransparent. It is made from a thin layer of Li (e.g., 1 nm) in contact with the organic EL media, a thin layer of Al (e.g., 10 nm) over the lithium, and a thicker layer of ITO (e.g. 100 nm) over the Al. The cathode makes contact to the second interconnect line 216 in the via.

To illustrate the layer order, the lower right corner of first electrode area is pictorially cut away to show the first electrode 204. The organic EL media layer 212 is described in more detail below, but it can contain one or several layers of different materials. The organic EL media layer 212 is provided over the entire first electrode 204 and over a portion of the insulation layer 244. The organic EL media layer does not extend into the via 246 or through the predetermined seal area 210. The second electrode 214 is patterned over the first electrode and into the via 246, but does not contact the first electrical interconnect line 206. The light-emitting area (pixel) is defined by the area of overlap of the first electrode 204 with the second electrode 214, wherein there is organic EL media sandwiched there between. Because the first electrode is reflective and opaque, and the second electrode is semitransparent, this light will emit in a direction away from substrate 202. This is referred to as a “top-emitting” OLED.

The second electrode 214 can be deposited and patterned using methods previously described.

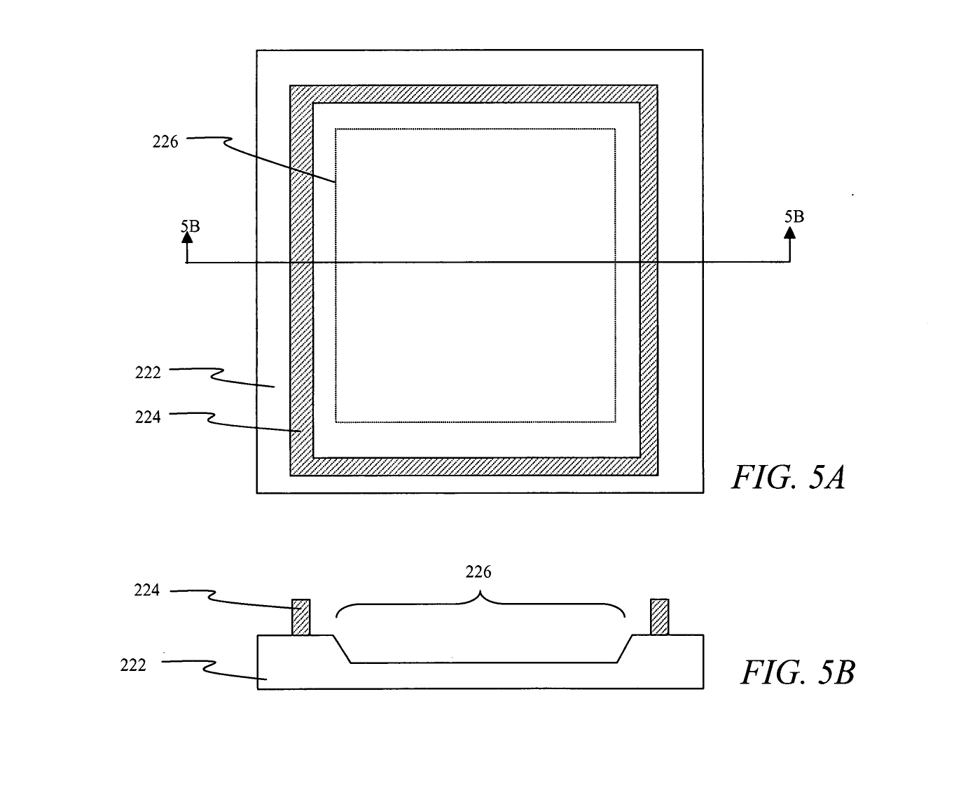

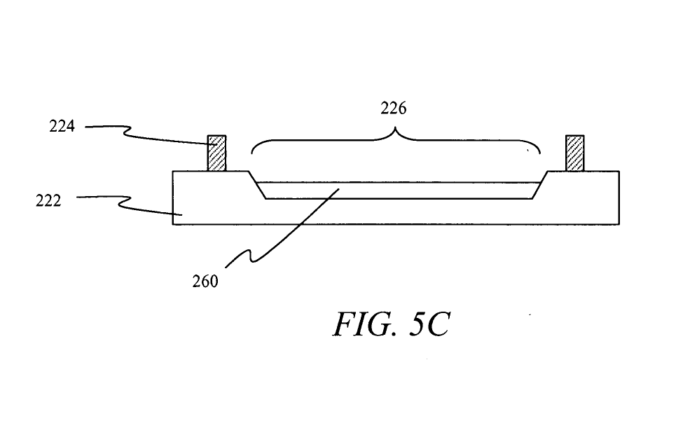

Turning now to FIG. 5, a cover 222 is shown having deposited thereon seal material 224 in a pattern corresponding to the predetermined seal area 210. A recessed area 226 is provided in the cover to hold the desiccant. The cover is preferably transparent glass in this arrangement. A transparent polymer cover can also be used if it is provided with a water impermeable layer(s) adjacent to the interface with the seal material. If this were a bottom-emitting OLED, an opaque cover such as a metal cover can be used.

The seal material 224 can be an organic adhesive such as UV or heat cured epoxy resin, acrylates, or pressure sensitive adhesive. Alternatively, the seal material can be a glass frit seal material or a metal solder. Such seals are activated by heating, for example with a laser, to cause the material to flow. A seal is formed when the seal material re-solidifies. It is desirable to maintain the sealing temperature as low as possible because OLED devices have thermally sensitive parts and coatings. Glass frit seal material can be lead-based, e.g., based on PbO—ZnO—B₂O₃. Preferably, the glass frit seal material is lead-free, e.g., based on ZnO—SnO—P₂O₅. The seal material should also provide a coefficient of thermal expansion (CTE) that is compatible with the CTE of the substrate.

FIG. 5C is a cross sectional view of the cover after Lewis acid organometallic desiccant 260 has been provided within the recessed portion of the cover. The desiccant is provided in a polymeric matrix from a solution and dried. The seal material 224 can be provided either before or after the desiccant. If the seal material 224 is polymer-based, it can optionally include a Lewis acid organometallic desiccant material of this invention to improve adhesive strength of the seal material when bonding a glass substrate to a glass cover.

The cover 222 with the patterned seal material 224 and desiccant 260 is provided over the OLED device 200A in alignment with the predetermined seal area. Pressure is applied between the substrate 202 and cover 222 while the seal material is cured or fused. The sealing step is preferably done under inert conditions such as under vacuum or under a dry nitrogen or argon atmosphere. The nitrogen or argon atmosphere can be at a pressure lower than atmospheric pressure.

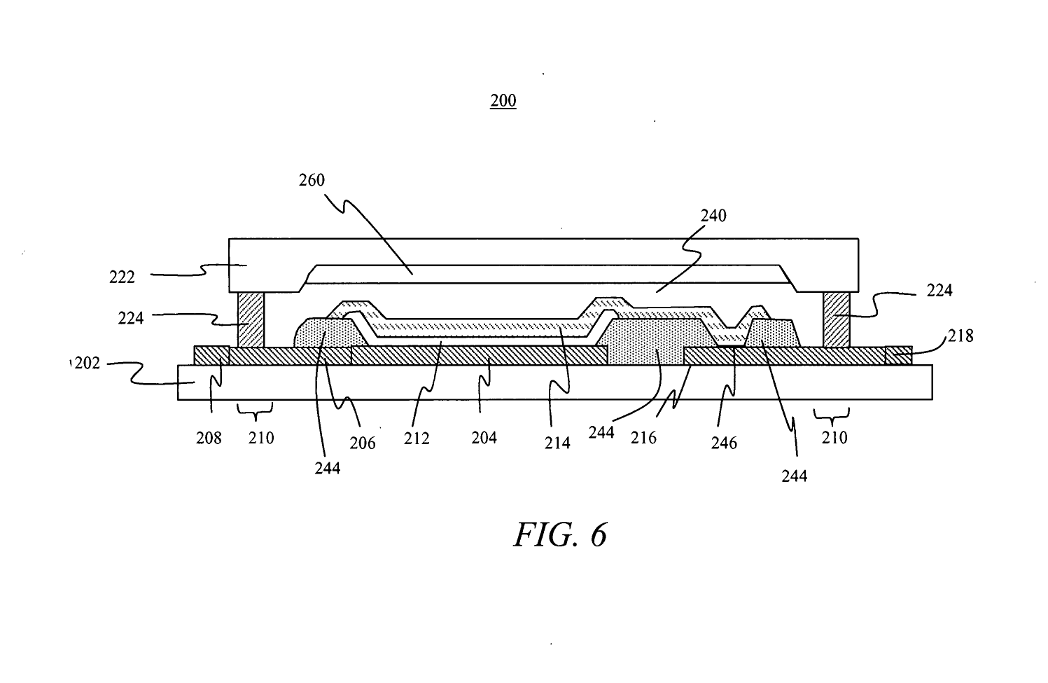

The resulting encapsulated OLED device is shown in FIG. 6. There is a space 240 between the second electrode and the cover 222 and desiccant 260. If the sealing step is done under nitrogen or argon, this space is filled with these gasses. If the pressure in space 240 is slightly reduced relative to atmospheric pressure, there can be an advantage of maintaining a pressure between the cover and the OLED substrate to ensure an effective seal. Further, if the space 240 is under slightly reduced pressure, then there is less chance of seal failure if the encapsulated OLED device is exposed to low pressures (e.g., transportation in the cargo bay of an airplane).

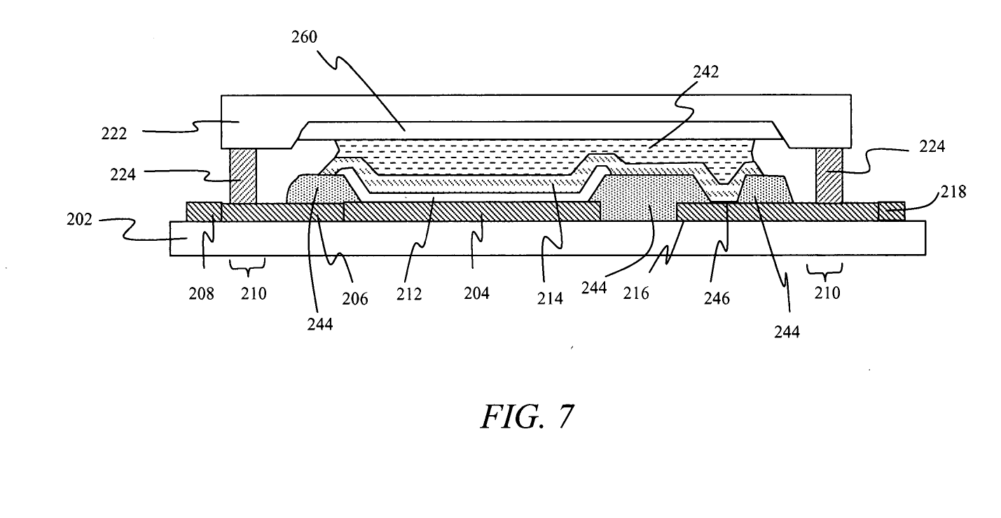

In a second embodiment, as shown in FIG. 7, this space between the cathode and the desiccant-filled cover can be filled with a polymer buffer layer 242. The polymer buffer layer 242 is selected to be transparent or nearly transparent, and having this layer between the cathode and the desiccant-filled cover can improve optical out-coupling. The polymer buffer layer 242 can be any number of materials including UV or heat cured epoxy resin, acrylates, or pressure sensitive adhesive. An example of a useful UV-curable epoxy resin is Optocast 3505 from Electronic Materials Inc. An example of useful pressure sensitive adhesive is Optically Clear Laminating Adhesive 8142 from 3M. The polymer buffer layer should be chosen so as not to react with the desiccant 260. If necessary, a layer can be provided between desiccant 260 and the polymer buffer layer 242 to prevent unwanted reactions or aid the optical outcoupling.

The invention has been described in detail with particular reference to certain preferred embodiments thereof, but it will be understood that variations and modifications can be effected within the spirit and scope of the invention.

### PARTS LIST

101 substrate
103 anode
105 hole-injecting layer
107 hole-transporting layer
109 light-emitting layer
111 electron-transporting layer
113 cathode
150 voltage/current source
160 electrical conductors
200 encapsulated OLED device
200A OLED device
202 OLED substrate
204 first electrode
206 first electrical interconnect line
208 first electrical contact pad
210 seal area
212 organic EL media layer
214 second electrode
216 second interconnect line
218 second contact pad
222 cover
224 seal material
226 recessed area
240 space
242 polymer buffer layer
244 insulation layer
246 via
260 desiccant

1. A desiccant for use in an electronic device that is moisture-sensitive comprising a Lewis acid organometallic structure that, when it reacts with water, forms a carbon-hydrogen bond but does not form an alcohol.

2. The desiccant of claim 1 wherein the Lewis acid has the formula
R¹ₙ-M-R²ₘ
wherein:
M is a metal;
R¹ is an organic substituent wherein at least one carbon is directly bonded to the metal;
R² is a silyl oxide wherein the oxygen is directly bonded to the metal, or an amide having a nitrogen directly bonded to the metal; and
n=1, 2, 3, or 4 and m=0, 1, 2, or 3 and are selected to fulfill the coordination requirements of M so that the formula is neutral in charge.

3. The desiccant of claim 2 wherein M is selected from Group IIB, IIIA, IIIB, or IVB.

4. The desiccant of claim 2 wherein M is selected from the first row transition metals.

5. The desiccant of claim 2 wherein M is Al, Zn, Ti, Mg, or B.

6. The desiccant of claim 2 wherein the moisture-sensitive device is a top- or bottom-emitting OLED device.

7. The desiccant of claim 2 wherein the amide includes 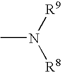
wherein R⁸ and R⁹ are organic substituents.

8. The desiccant of claim 7 wherein R⁸ or R⁹, or both, are part of an oligomeric or polymeric system.

9. The desiccant of claim 2 wherein the silyl oxide includes 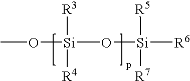
wherein R³ through R⁶ are organic substituents and p is an integer from 0 to 1000.

10. A desiccant for use in an electronic device that is moisture-sensitive comprising a Lewis acid organometallic structure that, when it reacts with water, forms a carbon-hydrogen bond but does not form an alcohol, and a matrix for carrying the Lewis acid organometallic structure.

11. The desiccant of claim 10 wherein the Lewis acid organometallic structure is molecularly dispersed within the matrix.

12. The desiccant of claim 10 wherein the matrix includes a polymeric material.

13. The desiccant of claim 1 wherein the moisture-sensitive device is a top- or bottom-emitting OLED device.

14. The desiccant of claim 13 wherein the desiccant provides an adhesive function for bonding a protective cover to an OLED substrate.

15. The desiccant of claim 1 wherein the Lewis acid has the formula
R¹ₙ-M-R²ₘ
wherein:
M is a metal;
R¹ is an organic substituent wherein at least one carbon is directly bonded to the metal;
R² is a silyl oxide wherein the oxygen is directly bonded to the metal, or an amide having a nitrogen directly bonded to the metal; and
n=1, 2, 3, or 4 and m=0, 1, 2, or 3 and are selected to fulfill the coordination requirements of M so that the formula is neutral in charge.

16. The desiccant of claim 15 wherein M is selected from Group IIB, IIIA, IIIB, or IVB.

17. The desiccant of claim 15 wherein M is selected from the first row transition metals.

18. The desiccant of claim 15 wherein M is Al, Zn, Ti, Mg, or B.

19. The desiccant of claim 15 wherein the amide includes 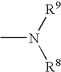
wherein R⁸ and R⁹ are organic substituents.

20. The desiccant of claim 19 wherein R⁸ or R⁹, or both, are part of an oligomeric or polymeric system.

21. The desiccant of claim 15 wherein the silyl oxide includes 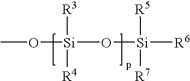
wherein R³ through R⁶ are organic substituents and p is an integer from 0 to 1000.
